(19) United States
(12) Patent Application Publication
(10) Pub. No.: US 2026/0119475 A1
(43) Pub. Date: Apr. 30, 2026

(54) CONSENT MANAGEMENT AND COORDINATION FOR REVERSE ETL

(71) Applicant: Twilio Inc., San Francisco, CA (US)

(72) Inventors: Aaron Klish, San Francisco, CA (US); Jayakrishnan Nair, San Francisco, CA (US); Anand Ramakrishnan, San Francisco, CA (US); Atit Shah, San Francisco, CA (US); Emma Sims, San Francisco, CA (US)

(21) Appl. No.: 19/005,703

(22) Filed: Dec. 30, 2024

Related U.S. Application Data
(63) Continuation-in-part of application No. 18/759,009, filed on Jun. 28, 2024.

(51) Int. Cl. G06F 16/23; G06F 16/25

(52) U.S. Cl. CPC G06F 16/2358; G06F 16/25

(57) ABSTRACT

Various embodiments described herein support or provide operations for facilitating consent management and coordination for reverse ETL. Specifically, a request to ingest consent preference data from a data source is received. A data model is identified based on the request. Data records associated with the data model storing the consent preference data are determined. Consent preference data to consent preference categories is mapped. Consent preference data and mappings are stored in user profiles. Consent preference data is transmitted to destinations based on the results of the mapping.

### CLAIM OF PRIORITY

This Application is a Continuation in Part of U.S. application Ser. No. 18/759,009, filed Jun. 28, 2024, which is hereby incorporated by reference in its entirety.

### TECHNICAL FIELD

The present disclosure generally relates to data management. More particularly, various embodiments described herein provide for systems, methods, techniques, instruction sequences, and devices that facilitate consent management and coordination for reverse ETL.

### BACKGROUND

In the realm of data processing, managing user consent has become increasingly complex due to the proliferation of digital platforms and the diverse regulations governing data privacy. The primary challenge in this field revolves around efficiently transmitting and synchronizing data from a consolidated storage location to multiple downstream applications and platforms. This process often involves complex data transformations to ensure compatibility with diverse target systems. Another challenge is maintaining data consistency and integrity across multiple systems while adhering to data privacy regulations and user preferences. This becomes particularly challenging as organizations deal with increasing volumes of data and a growing number of interconnected applications.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates consent management and coordination, according to various embodiments of the present disclosure.

FIG. 3 is a flowchart illustrating an example method for facilitating consent management and coordination for reverse ETL, according to various embodiments of the present disclosure.

FIG. 4 is a block diagram illustrating an example data management system that facilitates consent management and coordination for reverse ETL, according to various embodiments of the present disclosure.

FIG. 5 is a flowchart illustrating an example method for facilitating consent management and compliance with user consent preferences across multiple platforms, according to various embodiments of the present disclosure.

FIG. 6 is a flowchart illustrating an example method for facilitating consent management and compliance with user consent preferences across multiple platforms, according to various embodiments of the present disclosure.

FIG. 7 is a flowchart illustrating an example method for facilitating consent management and compliance with user consent preferences across multiple platforms, according to various embodiments of the present disclosure.

FIG. 8 is a flowchart illustrating an example method for facilitating consent management and compliance with user consent preferences across multiple platforms, according to various embodiments of the present disclosure.

FIG. 9 is a block diagram illustrating a data flow that facilitates consent management and coordination for reverse ETL, according to various embodiments of the present disclosure

FIG. 10 is a block diagram illustrating a representative software architecture, which may be used in conjunction with various hardware architectures herein described, according to various embodiments of the present disclosure.

FIG. 11 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate consent management and coordination for reverse ETL, according to various embodiments of the present disclosure. Reverse ETL (Extract, Transform, Load) refers to the process of moving data from a data warehouse or data lake back to operational databases, applications, or other data stores where it can be utilized for operational purposes. Unlike traditional ETL processes that move data from operational systems to data warehouses for analytics and reporting, reverse ETL facilitates the flow of data in the opposite direction. This allows organizations to operationalize insights gained from analytics and data processing by feeding them back into their operational systems, improving real-time decision-making and operational efficiency.

Various embodiments involve a consent-enforced reverse ETL activation process, addressing the challenge of managing user consent preferences when transferring data from data warehouses to various downstream applications and platforms. Specifically, a data management system receives one or more requests to ingest consent preference data from one or more data sources. Example data sources can include cloud data warehouses, hybrid data warehouses, and open-source data warehouses. A data warehouse can serve as a centralized repository that stores and manages customer data.

In various embodiments, the data management system identifies one or more data models based on a request. A data model is an abstract representation of the structure, relationships, and constraints of the data in a system. It can define how data is organized, stored, and accessed in databases or information systems. A data model can serve as a blueprint for designing and implementing databases by specifying what data is required and how it should be organized. As described herein, a data model identified based on a data ingestion request can define (or include) the consent preference data. Each data record associated with a data model can include a column identifier that is used to detect new, updated, and deleted data records. In various embodiments, a data model can include one or more Structured Query Language (SQL) queries that define consent preference data.

In various embodiments, the data management system determines that one or more data records associated with the data model store the consent preference data specified in a request.

In various embodiments, the data management system maps the consent preference data to one or more consent preference categories. In particular, the data management system organizes and handles user consent preferences by taking the specific consent data, such as whether a user has agreed to certain types of data usage or communications, and mapping it to predefined consent categories. These categories are broad groupings that represent different permissions, such as marketing consent, data sharing consent, and product update consent. This mapping process helps the system classify and apply user preferences consistently across various applications and processes, ensuring the user's data is used according to their consent.

In various embodiments, the data management system stores the consent preference data and the mapping between the consent preference data and one or more consent preference categories in one or more user profiles associated with the consent preference data. User profiles are associated with the individual users who provided the consent information. By organizing the consent data in this way, the system ensures that all preferences are easily accessible and can be quickly referenced whenever the user's consent needs to be verified or enforced. This storage step is important for maintaining compliance with regulations, allowing the system to track and respect each user's preferences over time. Additionally, it ensures that any changes to consent preferences, such as updates or withdrawals, can be seamlessly integrated into the system, preventing any unauthorized use of data. This systematic approach to storing consent information enables the organization to consistently apply the correct policies across all relevant platforms, safeguarding user privacy and ensuring adherence to legal and ethical standards.

Various embodiments involve a mechanism for handling requests to transmit data from customers'data warehouses to various destinations. Specifically, the data management system receives a request to transmit the consent preference data to a destination. A destination can refer to any external platform or tool where data is transmitted. When such a request is received, the data management system determines whether the relevant consent preference categories are assigned to the destination. If the categories are assigned and the user has provided consent, the data can be transmitted.

In various embodiments, if the categories were not assigned and/or consent preferences were not given, the transmission request can be denied and/or blocked. In various embodiments, if the data management system determines that consent preferences are not available for a customer entity associated with the request (e.g., categories were not assigned, consent preferences were not given), the data management system can allow the customer entity to configure the consent preferences for the users. For example, a customer entity can configure the configure the consent preferences as follows:
1. liberal—assume “true” for all missing or unavailable consent preferences;
2. conservative—assume “false” for all missing or unavailable consent preferences; or
3. category specific—“true” or “false” for all missing or unavailable consent preferences for a specific category.

In various embodiments, the consent preferences can be configured in an application or via SQL queries described herein.

In various embodiments, the preference categories are configured by a customer entity associated with the request. A customer entity can configure (or define) consent preference categories and can assign one or more consent preference categories to a destination. By ensuring that data adheres to the consent preference categories assigned to the destination, businesses can maintain compliance with data regulations (e.g., GDPR, CCPA) while delivering targeted audiences, fostering trust and integrity in data management practices.

In various embodiments, the data management system determines that the consent preference data corresponds to an event type associated with a predefined service. An event type can correspond to a user cohort condition or a group condition that affects the transmission of the consent preference data as one or more events of the event type to a destination. A user cohort can refer to a group of users who share common characteristics or experiences within a specified time frame. A user cohort condition or a group condition can specify criteria or rules that dictate how consent preference data is processed and transmitted based on user behavior or group attributes. In particular, A user cohort condition can be a set of rules or criteria that apply to a specific segment or group of users who share similar characteristics or behaviors. These conditions could be based on factors such as user demographics, actions taken within a platform, and past interactions. When an event type corresponds to a user cohort condition, it indicates that the transmission of consent preference data is influenced by whether a user falls within a particular cohort or not. For example, users who opted into marketing emails may form a cohort, and specific rules might apply to how their consent preferences are transmitted to a destination. A group condition can be a set of rules that applies to a broader grouping, which could be based on organizational structures, team memberships, or shared attributes across multiple users. When an event type corresponds to a group condition, it indicates that the transmission of consent preference data is affected by whether the user belongs to a particular group. For example, a group might be defined by a shared geographic location or membership in a particular customer tier, and this could influence how consent data is transmitted for that group.

In various embodiments, upon determining that the user cohort condition or the group condition is satisfied and that the consent preference data maps to one or more consent preference categories assigned to the destination, the data management system transmits the consent preference data to the destination. Under this approach, the system evaluates these conditions before transmitting data, adding another layer of control over data flow.

In various embodiments, the data management system also supports the generation and management of consent categories within the system. Users with appropriate permissions can create, edit, and disable consent categories, mapping them to specific destinations. This allows for fine-grained control over how consent is applied to different data flows.

By implementing the consent-enforced reverse ETL process described herein, organizations can maintain compliance with data privacy regulations while efficiently managing and activating their data across multiple platforms and applications.

Reference will now be made in detail to embodiments of the present disclosure, examples of which are illustrated in the appended drawings. The present disclosure may, however, be embodied in many different forms and should not be construed as being limited to the embodiments set forth herein.

Various embodiments include systems, methods, and non-transitory computer-readable media that facilitate consent management and compliance with user consent preferences across multiple platforms, according to various embodiments of the present disclosure. In today's interconnected digital environment, managing user consent across various platforms presents a significant challenge. Various embodiments involve addressing this challenge by providing a comprehensive solution for synchronizing and enforcing user consent preferences across multiple data processing platforms in real-time. Under this approach, organizations can efficiently adhere to user preferences and regulatory requirements, thereby maintaining trust and compliance.

Various embodiments involve the handling of several aspects of consent management and coordination by a data management system:

Consent Acquisition: This aspect involves gathering user consent preferences. A data management system operates through user interfaces such as webpages or mobile apps, where users can specify their consent preferences regarding how their data is used or shared. The system captures these preferences and accurately records them for downstream processing.

Consent Storage: After collecting user consent preferences, the data management system stores them in a database designed for secure consent records storage. The database makes the records readily accessible for querying and updates. It acts as the central repository for all consent-related information, ensuring that data is consistently available for synchronization and compliance checks.

Consent Synchronization: Changes in user consent are reflected across all platforms (e.g., destinations) that access or process the user's data. The data management system propagates updates throughout the system, ensuring that all data use remains in line with the latest user preferences. This synchronization can be performed in real-time and is vital for maintaining the integrity of consent across diverse systems and applications.

Notification: This aspect involves communication with users regarding any changes in data usage policies or to confirm or update their consent preferences. The data management system can generate and transmit notifications through various channels, such as email, SMS, or in-app notifications. It ensures that users are kept informed about how their data is being used and allows them to update their preferences if necessary.

Compliance Verification: This aspect involves monitoring the use of data across systems to ensure it aligns with user consent and complies with relevant data protection laws. The data management system can perform regular checks and audits to detect discrepancies or violations, providing reports and alerts to help organizations promptly address compliance issues.

Together, these aspects of the consent management and coordination mechanism form a comprehensive system designed to manage user consent effectively. Various embodiments tackle several challenges, including the need for real-time consent updates, maintaining compliance with diverse and evolving data protection regulations, and managing user preferences across multiple platforms. A robust framework is offered for organizations to manage user consent more effectively. By automating the synchronization of consent preferences and ensuring compliance across all data usage points, organizations can reduce the risk of data breaches and non-compliance penalties and enhance user trust by adhering to their data preferences consistently and transparently.

In various embodiments, the data management system allows customer entities (e.g., businesses, customers) to define categories of consent based on specific criteria or purposes and obtain consent for each of the categories from users. This categorization helps organizations manage and track various types of consent they receive from users regarding the use of their personal data or communication preferences. For example, the system allows customer entities to create categories such as “Marketing Consent,” “Transactional Consent,” “Preferences Consent,” or any other relevant categories based on their specific use case or regulatory requirements. Within each category, customer entities can define the scope and purpose of consent, along with any associated preferences or restrictions. By categorizing consent, organizations can better organize and manage their user consent data, ensure compliance with relevant regulations such as General Data Protection Regulation (GDPR) or California Consumer Privacy Act (CCPA), and tailor their data use and communication strategies to align with users'preferences. The data management system's support for defining categories of user consent provides customer entities with greater flexibility and control over how they handle and utilize consent within their applications or communication workflows.

In various embodiments, a data management system receives a request to transmit data to a destination. A destination can refer to any external platform or tool where data is transmitted. The data management system collects and manages customer data from various sources and routes that data to different destinations for analysis, marketing, or other purposes. Destinations can include analytics platforms, customer relationship management (CRM) systems, email marketing services, or any other tool or platform that benefits from the data collected by the data management system. The data associated with the request can include a consent preference. Consent preferences allow individuals to customize their communication experience and control how their personal data is used, ensuring that their privacy and preferences are respected by organizations. Examples (types) of consent preferences include the following, without limitations: preference for how personal data is shared with third parties for marketing or analytical purposes, including opt-in or opt-out options for data sharing; preference for receiving communication via email, SMS, phone calls, or physical mail; preference for the frequency of communication, such as daily, weekly, monthly, or only on special occasions; preference for the type of content received, such as newsletters, promotional offers, product updates, or informational content; preference for the level of personalization in communications, including tailored recommendations, personalized offers, or generic messages; preference for privacy settings related to data collection, tracking, and profiling, including granular controls over cookies, tracking pixels, and other tracking technologies.

In various embodiments, the data management system identifies a consent preference category assigned to the destination. Consent preference categories can be configured by a customer entity associated with the request. Consent preference categories can be configured based on content type, frequency of communication, language, personalization, data sharing, consent management, privacy settings, geographic targeting, and product or service preferences.

In various embodiments, the data management system determines that the consent preference associated with the data corresponds to (or maps to) one or more of the consent preference categories assigned to the destination. The data management system transmits the data to the destination based on (or in response to) the determining of the consent preference. In various embodiments, if data is mapped to one or more consent preference categories, customer entities can configure the system to allow: 1. data be sent only if users consent to all categories; 2. data be sent if users consent to any one of the categories. By ensuring that data adheres to the consent preference categories assigned to the destination, businesses can maintain compliance with data regulations (e.g., GDPR) while delivering targeted audiences, fostering trust and integrity in data management practices.

In various embodiments, there are conditions that need to be met before delivering data to destinations. Specifically, the data management system determines that the data associated with the request corresponds to an event type (e.g., enter events, exit events) of a predefined service. The event type corresponds to one or more conditions that affect the transmission to the requested destination. An example condition can correspond to a change of a trait value in a user profile associated with the data in the request. Another example of a condition can correspond to a change of consent preference made by a user associated with the data in the request. In various embodiments, a condition can refer to a user cohort condition or a group condition. The data management system allows the configuration (or building) of a user cohort. A user can enter or exit the cohort based on satisfying a user cohort condition. A user cohort can refer to a group of users who share common characteristics or experiences within a specified time frame.

In various embodiments, upon determining that one or more conditions (e.g., user cohort conditions, group conditions) are satisfied and that the consent preference corresponds to the consent preference category, the data management system can transmit the data to the destination, as requested.

In various embodiments, the data management system identifies a user profile associated with the user based on the data in the request. A user profile can include a variety of data points and attributes that provide a comprehensive understanding of an individual user. For example, a user profile can include a user identifier, age, gender, location, language preferences, and other relevant demographic details. An example user profile can also include consent preferences (e.g., opt-in or opt-out preferences for data collection and marketing communications), user traits (e.g., attributes assigned to the user based on their behavior, preferences, or other criteria defined by the business), user behavioral data (e.g., interaction with webpages, page views, clicks), event history (e.g., sign-ups, purchases, subscriptions), purchase history, engagement metrics (e.g., session duration, frequency of visits), etc.

User traits, in particular, encompass various aspects such as demographic information, behavioral patterns, preferences, interests, past interactions, and predicted future interactions. In a profile, user traits provide insights into who the user is, what they like, how they behave, and what they might be interested in. Organizations can collect and analyze user traits to personalize experiences, target marketing efforts, recommend relevant content, and tailor products or services to meet individual user needs, etc.

In various embodiments, the data management system determines that the consent preference associated with the request is different from a current consent preference of the same data type in the user profile. A consent preference can apply to one or more data types depending on the context and the regulations in place. For example, in the realm of data privacy and protection, consent preferences can apply to various types (or categories) of personal data such as basic personal information, sensitive personal information, biometric data, location data, behavioral data, genetic data, etc.

In response to determining that the consent preference is different, the data management system determines that the condition corresponding to a change of consent preference is satisfied. In response to determining that the condition corresponding to a change of consent preference is satisfied and that the consent preference corresponds to the consent preference category, the data management system can transmit the data to the requested destination.

In various embodiments, the data management system receives (or collects) consent preferences as user inputs via client devices (e.g., smartphones, tablets, computers, wearable devices, IoT devices). The data management system identifies a user profile based on a device identifier associated with a device, and saves the consent preference in the user profile. The consent preference can be associated with a timestamp indicating a time when the consent preference is received via the device. In various embodiments, a user profile can be identified based on a number of identifiers, including without limitation, email addresses, phone numbers, user identifiers, login IDs, device identifiers, etc.

In various embodiments, the data management system determines that the consent preference is different from a consent preference of the same data type already included in the user profile, indicating a change to the current preference. The data management system updates the consent preference of data associated with the same data type based on the consent preference associated with the request.

Reference will now be made in detail to embodiments of the present disclosure, examples of which are illustrated in the appended drawings. The present disclosure may, however, be embodied in many different forms and should not be construed as being limited to the embodiments set forth herein.

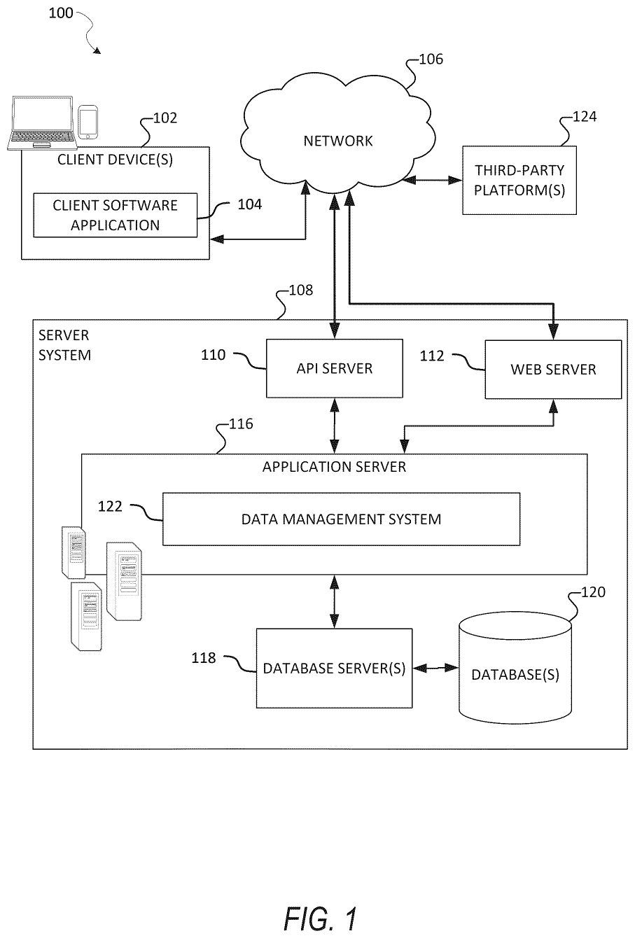

FIG. 1 is a block diagram showing an example data system 100 that includes a data management system 122 (also referred to as system 122), according to various embodiments of the present disclosure. By including the data management system 122, the data system 100 can facilitate consent management and compliance with user consent preferences across multiple platforms. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

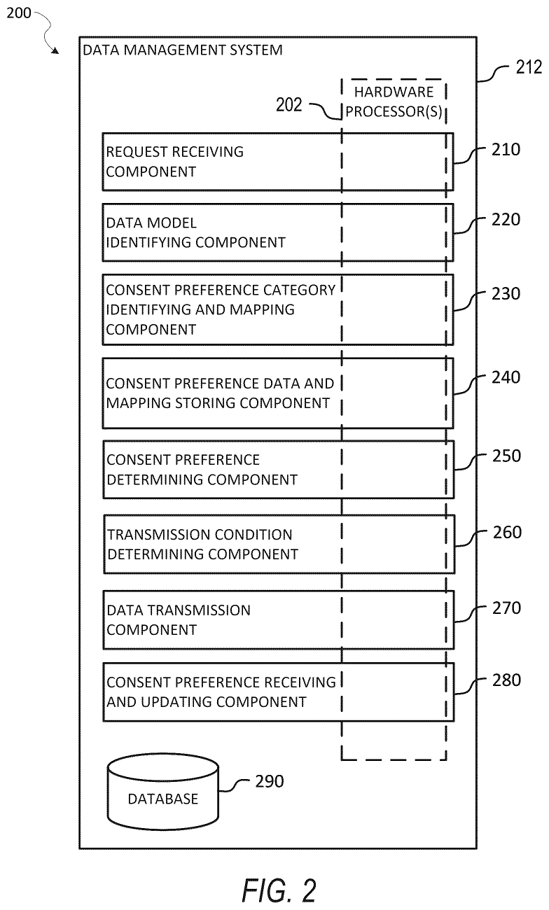

FIG. 2 is a block diagram 200 illustrating an example data management system 212 that facilitates consent management and compliance with user consent preferences across multiple platforms, according to various embodiments of the present disclosure. For some embodiments, the data management system 212 represents an example of the data management system 122 described with respect to FIG. 1. As shown, the data management system 212 comprises a request receiving component 210, a data model identifying component 220, a consent preference category identifying and mapping component 230, a consent preference data and mapping storing component 240, a consent preference determining component 250, a transmission condition determining component 260, a data transmission component 270, a consent preference receiving and updating component 280. According to various embodiments, one or more of the request receiving component 210, the data model identifying component 220, the consent preference category identifying and mapping component 230, the consent preference data and mapping storing component 240, the consent preference determining component 250, the transmission condition determining component 260, the data transmission component 270, the consent preference receiving and updating component 280 are implemented by one or more hardware processors 202. Data generated by one or more of the request receiving component 210, the data model identifying component 220, the consent preference category identifying and mapping component 230, the consent preference data and mapping storing component 240, the consent preference determining component 250, the transmission condition determining component 260, the data transmission component 270, the consent preference receiving and updating component 280 may be stored in a database (or datastore) 290 of the data management system 212.

The request receiving component 210 is configured to receive a request to transmit data to a destination. The data is associated with a consent preference. Consent preferences allow individuals to customize their communication experience and control how their personal data is used, ensuring that their privacy and preferences are respected by organizations. The request receiving component 210 is further configured to receive one or more requests to ingest consent preference data from one or more data sources. Example data sources can include cloud data warehouses, hybrid data warehouses, and open-source data warehouses.

The data model identifying component 220 is configured to identify one or more data models based on a request. A data model is an abstract representation of the structure, relationships, and constraints of the data in a system. It can define how data is organized, stored, and accessed in databases or information systems. Each data record associated with a data model can include a column identifier that is used to detect new, updated, and deleted data records. The data model identifying component 220 is further configured to determine that one or more data records associated with a data model store the consent preference data specified in a request.

The consent preference category identifying and mapping component 230 is configured to identify a consent preference category assigned to the destination. Consent preference categories can be configured based on content type, frequency of communication, language, personalization, data sharing, consent management, privacy settings, geographic targeting, and product or service preferences. The consent preference category identifying and mapping component 230 is further configured to map consent preference data to one or more consent preference categories. The consent preference categories are broad groupings that represent different permissions, such as marketing consent, data sharing consent, and product update consent. This mapping process helps the system classify and apply user preferences consistently across various applications and processes, ensuring the user's data is used according to their consent.

The consent preference data and mapping storing component 240 is configured to store the consent preference data and the mapping between the consent preference data and one or more consent preference categories in one or more user profiles associated with the consent preference data. User profiles are associated with the individual users who provided the consent information. By organizing the consent data in this way, the system ensures that all preferences are easily accessible and can be quickly referenced whenever the user's consent needs to be verified or enforced. This storage step is important for maintaining compliance with regulations, allowing the system to track and respect each user's preferences over time. Additionally, it ensures that any changes to consent preferences, such as updates or withdrawals, can be seamlessly integrated into the system, preventing any unauthorized use of data.

The consent preference determining component 250 is configured to determine that a consent preference in a request corresponds to (or maps to) one of the consent preference categories assigned to the destination. Consent preference categories can be configured (or defined) by a customer entity associated with the request. In various embodiments, a customer entity can generate a mapping between one or more consent preference categories and a destination. The consent preference determining component 250 is configured to determine if the consent preference in the request belongs to a consent preference category mapped to a requested destination. By ensuring that data adheres to the consent preference categories assigned to the destination, businesses can maintain compliance with data regulations (e.g., GDPR, CCPA) while delivering targeted audiences, fostering trust and integrity in data management practices.

The transmission condition determining component 260 is configured to determine if one or more conditions need to be met before delivering data to destinations. In particular, the transmission condition determining component 260 is configured to determine that the data associated with the request corresponds to an event type (e.g., enter events, exit events) of a predefined service. The event type corresponds to one or more conditions that affect the transmission to the requested destination. An example condition can correspond to a change of a trait value in a user profile associated with the data in the request. Another example of a condition can correspond to a change of consent preference made by a user associated with the data in the request.

The data transmission component 270 is configured to transmit the data to the requested destination upon determining that one or more conditions are satisfied.

The consent preference receiving and updating component 280 is configured to receive (or collect) consent preferences as user inputs via various types of client devices (e.g., smartphones, tablets, computers, wearable devices, IoT devices). The consent preference receiving and updating component 280 is configured to identify user profiles based on device identifiers associated with the client devices via which the consent preferences were received. Then, the consent preferences are either saved or updated in the user profiles depending on whether the profiles already include previously recorded preferences for the same data type. A consent preference can be associated with a timestamp indicating when the consent preference is received (or collected) via a device. In various embodiments, changes to consent preferences can also be sent to destinations. The data management systems can maintain a complete history (e.g., audit history) of all the changes made to consent preferences in a user profile. In various embodiments, consent preferences can be reconstructed at any point in time based on data included in a given user profile.

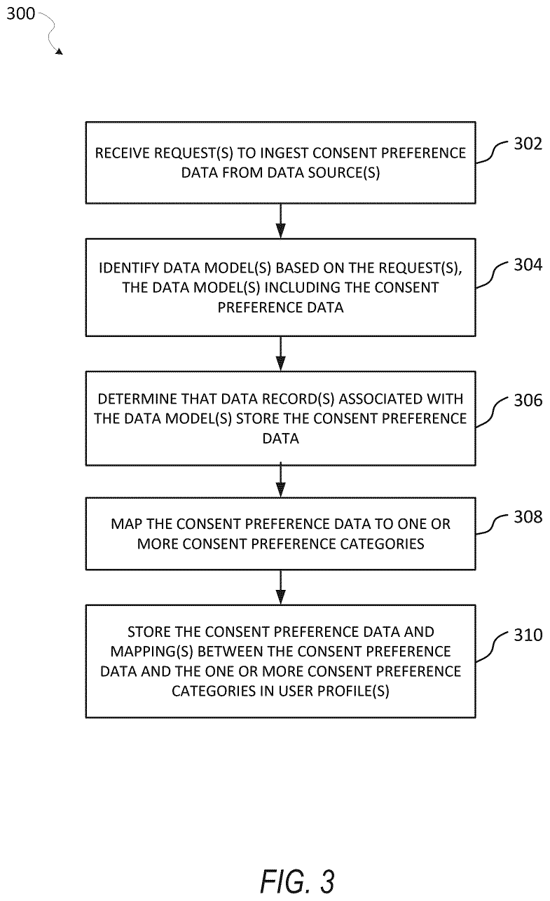

FIG. 3 is a flowchart illustrating an example method 300 for facilitating consent management and coordination for reverse ETL, according to various embodiments of the present disclosure. It will be understood that example methods described herein may be performed by a machine in accordance with some embodiments. For example, method 300 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor receives one or more requests to ingest consent preference data from one or more data sources. Example data sources can include cloud data warehouses, hybrid data warehouses, and open-source data warehouses. A data warehouse can serve as a centralized repository that stores and manages customer data.

At operation 304, a processor identifies one or more data models based on a request. A data model is an abstract representation of the structure, relationships, and constraints of the data in a system. It can define how data is organized, stored, and accessed in databases or information systems. A data model can serve as a blueprint for designing and implementing databases by specifying what data is required and how it should be organized. As described herein, a data model identified based on a data ingestion request can define (or include) the consent preference data. Each data record associated with a data model can include a column identifier that is used to detect new, updated, and deleted data records.

At operation 306, a processor determines that one or more data records associated with the data model store the consent preference data specified in a request. For example, a processor can query the data model and identify one or more data records that store a user's cookie preferences and/or user data governed by the user's cookie preferences.

At operation 308, a processor maps the consent preference data to one or more consent preference categories. Consent preference categories can be broad groupings that represent different permissions, such as marketing consent, data sharing consent, and product update consent. This mapping process helps the system classify and apply user preferences consistently across various applications and processes, ensuring the user's data is used according to their consent.

At operation 310, a processor stores the consent preference data and the mapping between the consent preference data and one or more consent preference categories in one or more user profiles associated with the consent preference data. User profiles are associated with the individual users who provided the consent information. By organizing the consent data in this way, the system ensures that all preferences are easily accessible and can be quickly referenced whenever the user's consent needs to be verified or enforced. This storage step is important for maintaining compliance with regulations, allowing the system to track and respect each user's preferences over time. Additionally, it ensures that any changes to consent preferences, such as updates or withdrawals, can be seamlessly integrated into the system, preventing any unauthorized use of data.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 310 or, alternatively, form part of one or more of operations 302 through 310.

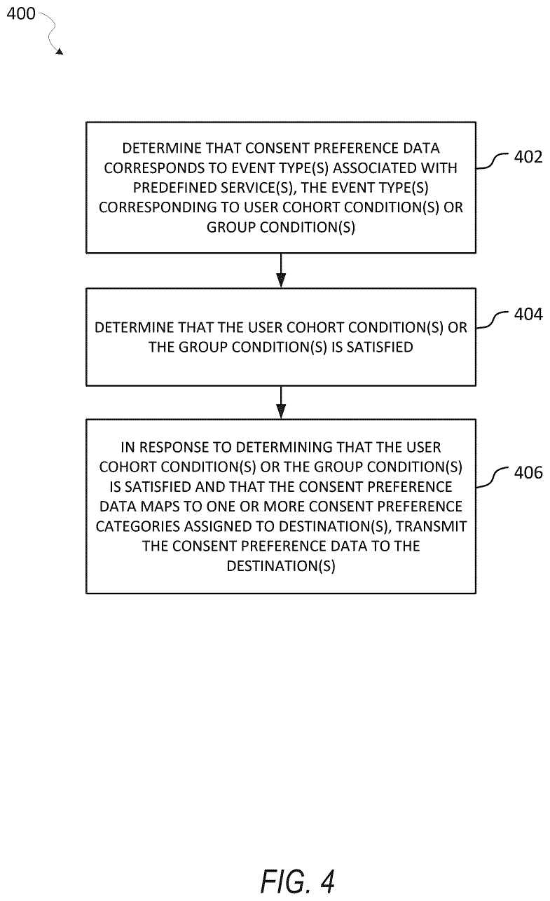

FIG. 4 is a flowchart illustrating an example method 400 for facilitating consent management and coordination for reverse ETL, according to various embodiments of the present disclosure. It will be understood that example methods described herein may be performed by a machine in accordance with some embodiments. For example, method 400 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor determines that the consent preference data corresponds to an event type associated with a predefined service. An event type can correspond to a user cohort condition or a group condition that affects the transmission of the consent preference data as one or more events of the event type to a destination. A user cohort can refer to a group of users who share common characteristics or experiences within a specified time frame. A user cohort condition or a group condition can specify criteria or rules that dictate how consent preference data is processed and transmitted based on user behavior or group attributes. In particular, A user cohort condition can be a set of rules or criteria that apply to a specific segment or group of users who share similar characteristics or behaviors.

At operation 404, a processor determines that the user cohort condition or the group condition is satisfied.

At operation 406, upon determining that the user cohort condition or the group condition is satisfied and that the consent preference data maps to one or more consent preference categories assigned to the destination, a processor transmits the consent preference data to the destination. Under this approach, the system evaluates these conditions before transmitting data, adding another layer of control over data flow.

Though not illustrated, method 400 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

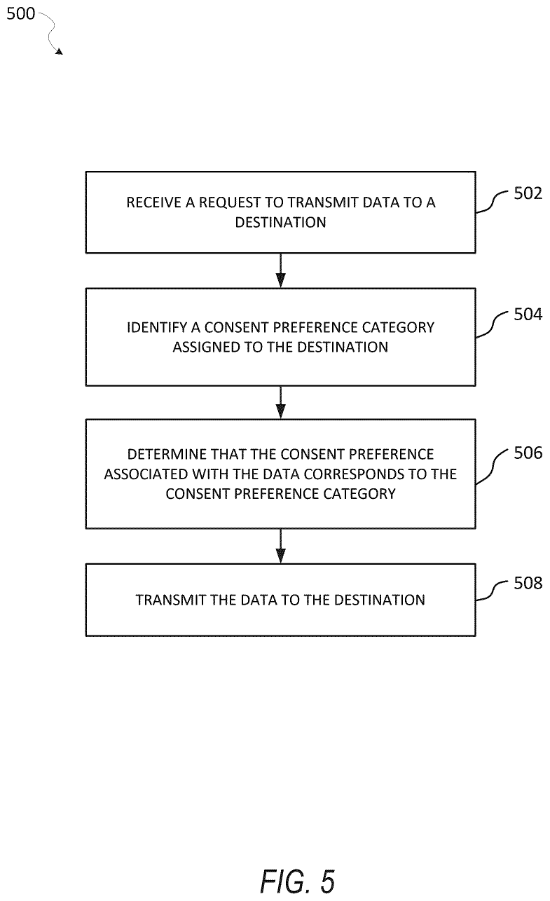

FIG. 5 is a flowchart illustrating an example method 500 for facilitating consent management and compliance with user consent preferences across multiple platforms, according to various embodiments of the present disclosure. It will be understood that example methods described herein may be performed by a machine in accordance with some embodiments. For example, method 500 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 500 can be performed dependently or independently from operations in method 300 and method 400.

At operation 502, a processor receives a request to transmit data to a destination. The data is associated with a consent preference. Consent preferences allow individuals to customize their communication experience and control how their personal data is used, ensuring that their privacy and preferences are respected by organizations. A destination can refer to any external platform or tool where data is transmitted.

At operation 504, a processor identifies a consent preference category assigned to the destination. Consent preference categories can be configured based on content type, frequency of communication, language, personalization, data sharing, consent management, privacy settings, geographic targeting, and product or service preferences. In various embodiments, customer entities (e.g., businesses, customers) can define categories of consent preference based on specific criteria or purposes and obtain consent for each of the categories from users. This categorization helps customer entities manage and track various types of consent they receive from users regarding the use of their personal data or communication preferences.

At operation 506, a processor determines that the consent preference associated with the data corresponds to (or maps to) the consent preference category. A customer entity can configure (or define) consent preference categories and can assign one or more consent preference categories to a destination. By ensuring that data adheres to the consent preference categories assigned to the destination, businesses can maintain compliance with data regulations (e.g., GDPR, CCPA) while delivering targeted audiences, fostering trust and integrity in data management practices.

At operation 508, a processor transmits the data to the destination at least based on the determination that the consent preference associated with the data corresponds to (or maps to) the consent preference category assigned to the destination. In various embodiments, changes made to the consent preference can be transmitted to the destination.

Though not illustrated, method 500 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 502 through 508 or, alternatively, form part of one or more of operations 502 through 508.

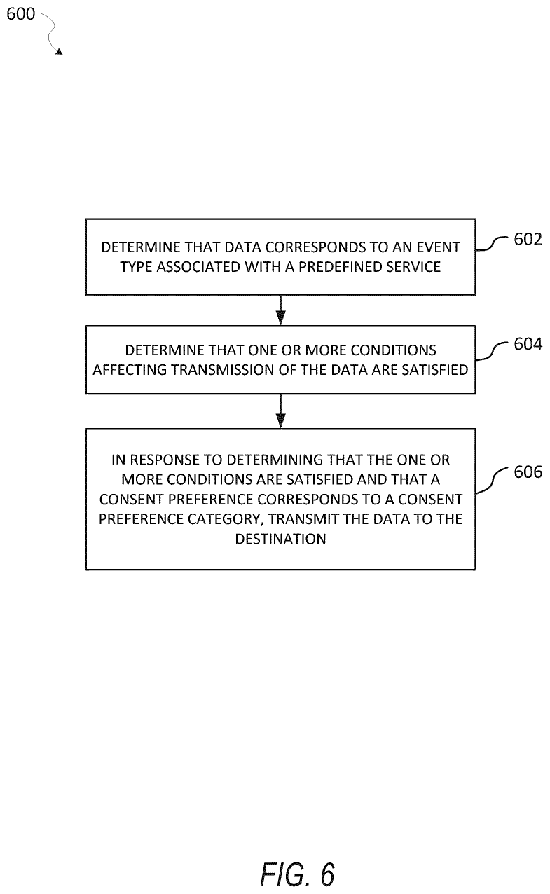

FIG. 6 is a flowchart illustrating an example method 600 for facilitating consent management and compliance with user consent preferences across multiple platforms, according to various embodiments of the present disclosure. It will be understood that example methods described herein may be performed by a machine in accordance with some embodiments. For example, method 600 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 600 may be represented by executable instructions that, when executed by a processor of a computing device, cause the computing device to perform method 600. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 600 can be performed dependently or independently from operations in method 300, method 400, and method 500.

At operation 602, a processor determines that data corresponds to an event type (e.g., enter events, exit events) associated with a predefined service. An event type can correspond to one or more conditions that affect the transmission to the requested destination. For example, enter events can only be sent to a specific destination when the user profile satisfies a definition associated with a service. In another example, events associated with a particular service can only be sent when there is a change to a trait value in the associated user profile.

At operation 604, a processor determines that one or more conditions that affect the transmission of the data are satisfied. A condition can refer to a user cohort condition or a group condition. The data management system allows the configuration (or building) of a user cohort. A user can enter or exit the cohort based on satisfying a user cohort condition. A user cohort can refer to a group of users who share common characteristics or experiences within a specified time frame.

At operation 606, a processor transmits the data to the destination in response to determining that the one or more conditions are satisfied and that a consent preference corresponds to a consent preference category.

Though not illustrated, method 600 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 602 through 606 or, alternatively, form part of one or more of operations 602 through 606.

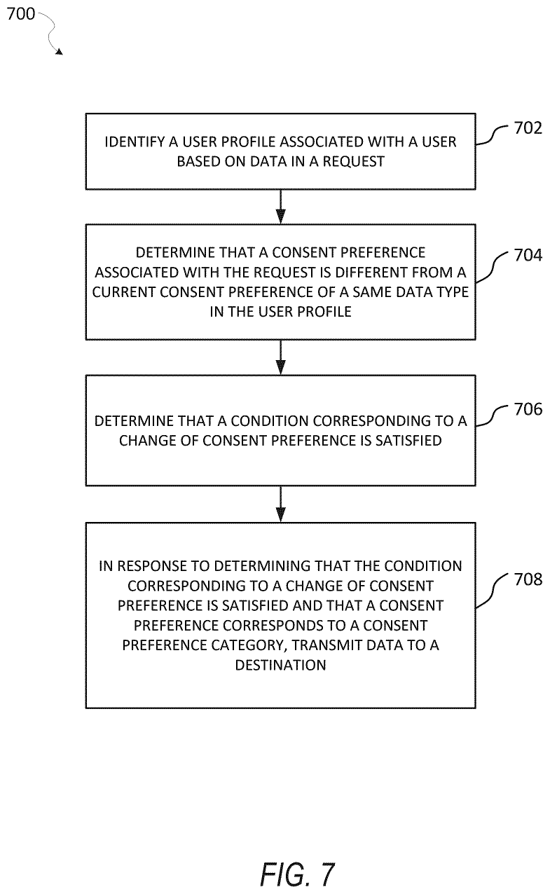

FIG. 7 is a flowchart illustrating an example method 700 for facilitating consent management and compliance with user consent preferences across multiple platforms, according to various embodiments of the present disclosure. It will be understood that example methods described herein may be performed by a machine in accordance with some embodiments. For example, method 700 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 700 may be represented by executable instructions that, when executed by a processor of a computing device, cause the computing device to perform method 700. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 700 can be performed dependently or independently from operations in method 300, method 400, method 500, and method 600.

At operation 702, a processor identifies a user profile associated with a user based on data in a request. A user profile can include a variety of data points and attributes that provide a comprehensive understanding of an individual user. For example, a user profile can include a user identifier, age, gender, location, language preferences, and other relevant demographic details. An example user profile can also include consent preferences (e.g., opt-in or opt-out preferences for data collection and marketing communications), user traits (e.g., attributes assigned to the user based on their behavior, preferences, or other criteria defined by the business), user behavioral data (e.g., interaction with webpages, page views, clicks), event history (e.g., sign-ups, purchases, subscriptions), purchase history, engagement metrics (e.g., session duration, frequency of visits), etc.

At operation 704, a processor determines that a consent preference associated with the request is different from a current consent preference of the same data type in the user profile, indicating a change of a consent preference. For example, a user can initially agree to share location data with a mobile app for personalized recommendations. However, after using the app for some time, the user becomes concerned about privacy and decides to revoke the location-sharing consent.

At operation 706, a processor determines that a condition corresponding to a change of consent preference is satisfied.

At operation 708, a processor transmits the data to the destination in response to determining that the condition corresponding to a change of consent preference is satisfied and that a consent preference corresponds to a consent preference category.

Though not illustrated, method 700 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 702 through 708 or, alternatively, form part of one or more of operations 702 through 708.

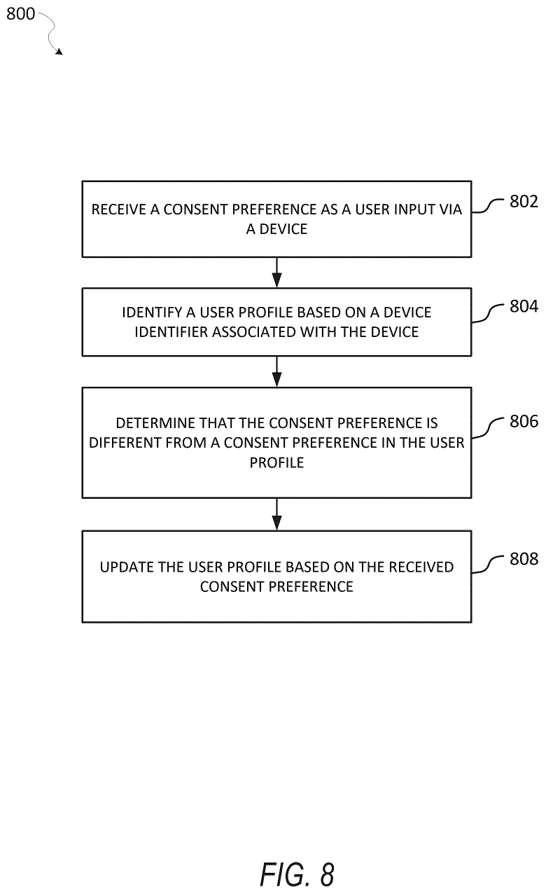

FIG. 8 is a flowchart illustrating an example method 800 for facilitating consent management and compliance with user consent preferences across multiple platforms, according to various embodiments of the present disclosure. It will be understood that example methods described herein may be performed by a machine in accordance with some embodiments. For example, method 800 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 800 may be represented by executable instructions that, when executed by a processor of a computing device, cause the computing device to perform method 800. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 800 can be performed dependently or independently from operations in method 300, method 400, method 500, method 600, and method 700.

At operation 802, a processor receives a consent preference as a user input via a device (e.g., smartphones, tablets, computers, wearable devices, IoT devices).

At operation 804, a processor identifies a user profile based on a device identifier associated with the device.

At operation 806, a processor determines that the consent preference is different from a consent preference of the same data type in the user profile.

At operation 808, a processor updates the user profile based on the received consent preference. Updating user profiles enables other platforms and/or systems with access to the profiles to retrieve the latest data, thus ensuring synchronization and data integrity across multiple platforms.

Though not illustrated, method 800 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 802 through 808 or, alternatively, form part of one or more of operations 802 through 808.

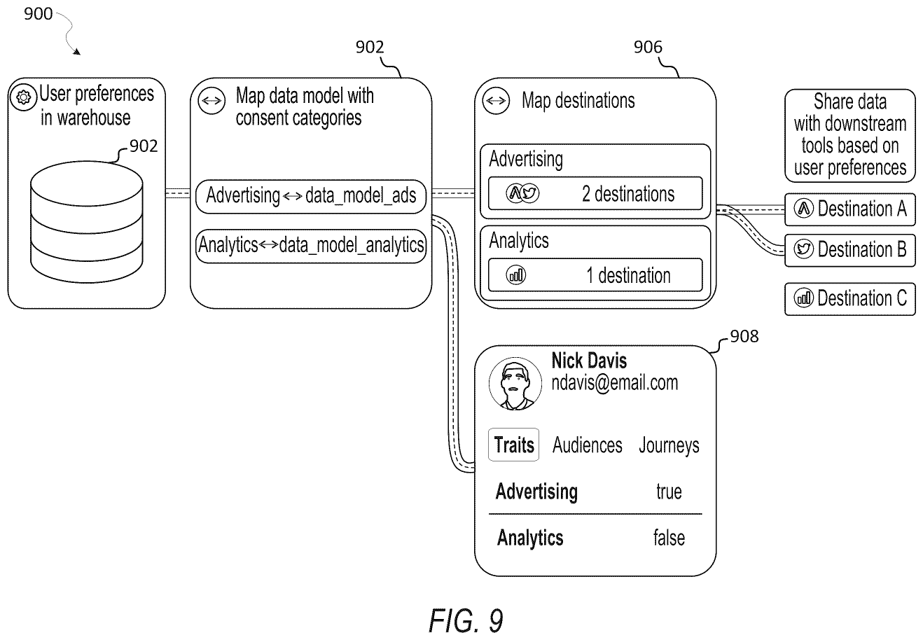

FIG. 9 is a block diagram illustrating a data flow 900 that facilitates consent management and coordination for reverse ETL, according to various embodiments of the present disclosure. As shown, data flow 900 depicts an example sequence of operations of consent-enforced Reverse ETL where data retrieved from a customer's warehouse 902 is evaluated against consent categories before transmitting to various destinations (e.g., Destinations A, B, C). Although the data flow 900 depicts a particular sequence of operations, the flow may be altered without departing from the scope of the present disclosure. For example, some of the operations depicted may be performed in parallel or in a different sequence that does not materially affect the function of the method. Different components of an example device or system that implements the method may perform functions at substantially the same time or in a specific sequence.

As shown, upon receiving requests to ingest data (e.g., consent preference data) from a data source (e.g., data warehouse 902), the data management system (e.g., systems 122, 212), at block 902, identifies data models that include the requested data and map the requested data (or the data models) to one or more consent categories. Based on the mapping, the data management system can either transmit the requested data to one or more destinations specified in the requests or deny the requests. The data management system can also store the mapping along with the requested data to one or more corresponding user profiles (e.g., user profile 908).

The data flow 900 may also include additional operations not explicitly shown in the block diagram. For instance, the system may continuously update the data model based on new user inputs (e.g., changing consent preferences). In some examples, the system may employ machine learning technologies to refine the data flow over time. In various embodiments, the data flow may incorporate feedback loops, where the outcomes of data processing inform future mapping and segmentation processes. This iterative approach can enable the data management system to adapt to changing user preferences and evolving data usage scenarios in digital environments.

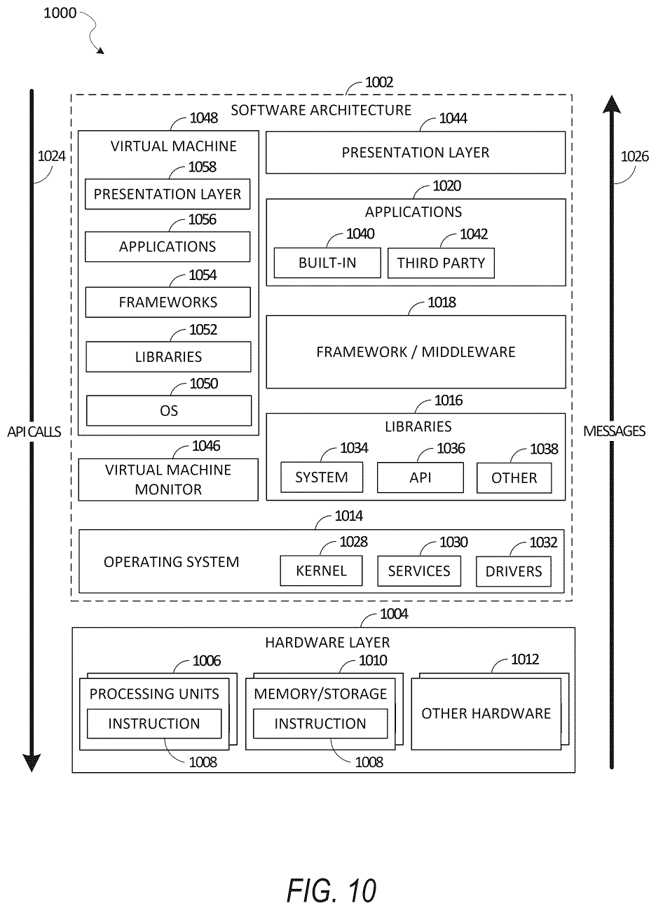

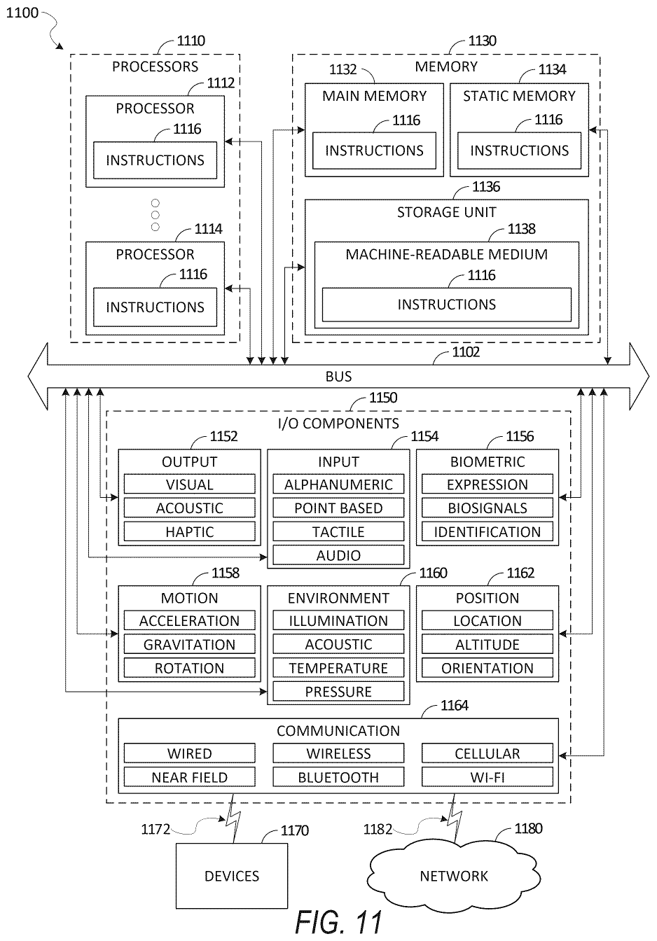

FIG. 10 is a block diagram illustrating an example of a software architecture 1002 that may be installed on a machine, according to some example embodiments. FIG. 10 is merely a non-limiting example of a software architecture, and it will be appreciated that many other architectures may be implemented to facilitate the functionality described herein. The software architecture 1002 may be executing on hardware such as a machine 1100 of FIG. 11 that includes, among other things, processors 1110, memory 1130, and input/output (I/O) components 1150. A representative hardware layer 1004 is illustrated and can represent, for example, the machine 1100 of FIG. 11. The representative hardware layer 1004 comprises one or more processing units 1006 having associated executable instructions 1008. The executable instructions 1008 represent the executable instructions of the software architecture 1002. The hardware layer 1004 also includes memory or storage modules 1010, which also have the executable instructions 1008. The hardware layer 1004 may also comprise other hardware 1012, which represents any other hardware of the hardware layer 1004, such as the other hardware illustrated as part of the machine 1100.

In the example architecture of FIG. 10, the software architecture 1002 may be conceptualized as a stack of layers, where each layer provides particular functionality. For example, the software architecture 1002 may include layers such as an operating system 1014, libraries 1016, frameworks/middleware 1018, applications 1020, and a presentation layer 1044. Operationally, the applications 1020 or other components within the layers may invoke API calls 1024 through the software stack and receive a response, returned values, and so forth (illustrated as messages 1026) in response to the API calls 1024. The layers illustrated are representative in nature, and not all software architectures have all layers. For example, some mobile or special-purpose operating systems may not provide a frameworks/middleware 1018 layer, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than by interfacing directly with the underlying operating system 1014 functionality (e.g., kernel 1028, services 1030, or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 or other software components/modules. For example, the frameworks 1018 may provide various graphical user interface functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 include built-in applications 1040 and/or third-party applications 1042. Examples of representative built-in applications 1040 may include, but are not limited to, a home application, a contacts application, a browser application, a book reader application, a location application, a media application, a messaging application, or a game application.

The third-party applications 1042 may include any of the built-in applications 1040, as well as a broad assortment of other applications. In a specific example, the third-party applications 1042 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1042 may invoke the API calls 1024 provided by the mobile operating system such as the operating system 1014 to facilitate functionality described herein.

The applications 1020 may utilize built-in operating system functions (e.g., kernel 1028, services 1030, or drivers 1032), libraries (e.g., system libraries 1034, API libraries 1036, and other libraries 1038), or frameworks/middleware 1018 to create user interfaces to interact with users of the system. Alternatively, or additionally, in some systems, interactions with a user may occur through a presentation layer, such as the presentation layer 1044. In these systems, the application/module “logic” can be separated from the aspects of the application/module that interact with the user.

Some software architectures utilize virtual machines. In the example of FIG. 10, this is illustrated by a virtual machine 1048. The virtual machine 1048 creates a software environment where applications/modules can execute as if they were executing on a hardware machine (e.g., the machine 1100 of FIG. 11). The virtual machine 1048 is hosted by a host operating system (e.g., the operating system 1014) and typically, although not always, has a virtual machine monitor 1046, which manages the operation of the virtual machine 1048 as well as the interface with the host operating system (e.g., the operating system 1014). A software architecture executes within the virtual machine 1048, such as an operating system 1050, libraries 1052, frameworks 1054, applications 1056, or a presentation layer 1058. These layers of software architecture executing within the virtual machine 748 can be the same as corresponding layers previously described or may be different.

FIG. 11 illustrates a diagrammatic representation of a machine 1100 in the form of a computer system within which a set of instructions may be executed for causing the machine 1100 to perform any one or more of the methodologies discussed herein, according to an embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example, the instructions 1116 may cause the machine 1100 to execute the method 300 described above with respect to FIG. 3, the method 400 described above with respect to FIG. 4, the method 500 described above with respect to FIG. 5, the method 600 described above with respect to FIG. 6, the method 700 described above with respect to FIG. 7, and the method 800 described above with respect to FIG. 8. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an embodiment, the processors 1110 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors 1110, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136 including machine-readable medium 1138, each accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In some examples, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 1150 may include biometric components 1156, motion components 1158, environmental components 1160, or position components 1162, among a wide array of other components. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1100 including processors 1110), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1100, but deployed across a number of machines 1100. In some example embodiments, the processors 1110 or processor-implemented modules are located in a single geographic location (e.g., within a home environment, an office environment, or a server farm). In other example embodiments, the processors or processor-implemented modules are distributed across a number of geographic locations.

The various memories (i.e., 1130, 1132, 1134, and/or the memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 1180 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
receiving a request to ingest consent preference data from a data source;
identifying a data model based on the request, the data model including the consent preference data;
determining that one or more data records associated with the data model store the consent preference data;
mapping the consent preference data to one or more consent preference categories; and
storing the consent preference data and a mapping between the consent preference data and the one or more consent preference categories in one or more user profiles associated with the consent preference data.

2. The method of claim 1, comprising:
receiving a request to transmit the consent preference data to a destination.

3. The method of claim 2, comprising:
determining that the one or more consent preference categories are assigned to the destination; and
transmitting the consent preference data to the destination.

4. The method of claim 2, comprising:
determining that the one or more consent preference categories are not assigned to the destination; and
denying the request to transmit the consent preference data to the destination.

5. The method of claim 1, wherein the one or more consent preference categories are configured by a customer entity associated with the request.

6. The method of claim 1, wherein the data source comprises one of a cloud data warehouse, a hybrid data warehouse, and an open-source data warehouse, and wherein the data source corresponds to a centralized repository that stores and manages customer data of a customer entity associated with the request.

7. The method of claim 1, wherein the data model comprises one or more Structured Query Language (SQL) queries that define the consent preference data.

8. The method of claim 1, wherein each data record associated with the data model comprises a column identifier used to detect new, updated, and deleted data records.

9. The method of claim 1, comprising:
determining that the consent preference data corresponds to an event type associated with a predefined service, the event type corresponding to a user cohort condition or a group condition that affects transmission of the consent preference data as one or more events of the event type to a destination.

10. The method of claim 9, comprising:
determining that the user cohort condition or the group condition is satisfied; and
in response to determining that the user cohort condition or the group condition is satisfied and that the consent preference data maps to the one or more consent preference categories assigned to the destination, transmitting the consent preference data to the destination.

11. A system comprising:
one or more hardware processors; and
at least one machine-storage medium for storing instructions that, when executed by the one or more hardware processors, cause the one or more hardware processors to perform operations comprising:
receiving a request to ingest consent preference data from a data source;
identifying a data model based on the request, the data model including the consent preference data;
determining that one or more data records associated with the data model store the consent preference data;
mapping the consent preference data to one or more consent preference categories; and
storing the consent preference data and a mapping between the consent preference data and the one or more consent preference categories in one or more user profiles associated with the consent preference data.

12. The system of claim 11, wherein the operations comprise:
receiving a request to transmit the consent preference data to a destination.

13. The system of claim 12, wherein the operations comprise:
determining that the one or more consent preference categories are assigned to the destination; and
transmitting the consent preference data to the destination.

14. The system of claim 12, wherein the operations comprise:
determining that the one or more consent preference categories are not assigned to the destination; and
denying the request to transmit the consent preference data to the destination.

15. The system of claim 11, wherein the one or more consent preference categories are configured by a customer entity associated with the request.

16. The system of claim 11, wherein the data source comprises one of a cloud data warehouse, a hybrid data warehouse, and an open-source data warehouse, and wherein the data source corresponds to a centralized repository that stores and manages customer data of a customer entity associated with the request.

17. The system of claim 11, wherein the data model comprises one or more Structured Query Language (SQL) queries that define the consent preference data, and wherein each data record associated with the data model comprises a column identifier used to detect new, updated, and deleted data records.

18. The system of claim 11, wherein the operations comprise:
determining that the consent preference data corresponds to an event type associated with a predefined service, the event type corresponding to a user cohort condition or a group condition that affects transmission of the consent preference data as one or more events of the event type to a destination.

19. The system of claim 18, wherein the operations comprise:
determining that the user cohort condition or the group condition is satisfied; and
in response to determining that the user cohort condition or the group condition is satisfied and that the consent preference data maps to the one or more consent preference categories assigned to the destination, transmitting the consent preference data to the destination.

20. A machine-storage medium for storing instructions that, when executed by one or more hardware processors, cause the one or more hardware processors to perform operations comprising:
receiving a request to ingest consent preference data from a data source;
identifying a data model based on the request, the data model including the consent preference data;
determining that one or more data records associated with the data model store the consent preference data;
mapping the consent preference data to one or more consent preference categories; and
storing the consent preference data and a mapping between the consent preference data and the one or more consent preference categories in one or more user profiles associated with the consent preference data.
